(19) United States
(12) Patent Application Publication
(10) Pub. No.: US 2026/0351162 A1
(43) Pub. Date: Nov. 5, 2026

(54) DISPLAY DEVICE AND ELECTRONIC DEVICE INCLUDING THE SAME

(71) Applicant: SAMSUNG DISPLAY CO., LTD., YONGIN-SI (KR)

(72) Inventor: JEONGMIN SEO, Yongin-si (KR)

(21) Appl. No.: 19/457,382

(22) Filed: Jan. 23, 2026

(30) Foreign Application Priority Data
Apr. 30, 2025 (KR) 10-2025-0057256

(51) Int. Cl. G09G 3/32

(52) U.S. Cl. CPC G09G 3/32; G09G 2320/0247; G09G 2330/021

(57) ABSTRACT

A display device may include a display panel and a voltage generator supplying a panel power voltage to the display panel based on an input voltage. The voltage generator may control an output level of the panel power voltage by switching its operation mode between a low power mode and a normal mode based on magnitude of a load current relative to a threshold current. The voltage generator controls a voltage level of the panel power voltage. The threshold current increases as an absolute value of the panel power voltage decreases. When an absolute value of the panel power voltage becomes lower than an absolute value of a reference power voltage, the threshold current instantaneously decreases to reduce threshold current difference between the low power mode and the normal mode, thereby suppressing occurrences of flicker on the display panel.

### CROSS-REFERENCE TO RELATED APPLICATION(S)

This application claims priority under 35 USC § 119 to Korean Patent Application No. 10-2025-0057256, filed on Apr. 30, 2025 in the Korean Intellectual Property Office KIPO, the content of which is incorporated by reference herein in its entirety.

### Technical Field

Embodiments of the present inventive concept relate to a display device and an electronic device including the same. More particularly, embodiments of the present inventive concept relate to a display device operating in a low power mode or a normal mode and to an electronic device including the same.

### Discussion of the Related Art

A display device may include a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

The display device may may further include a voltage generator. The voltage generator may generate a panel power voltage using an input voltage and apply the panel power voltage to the display panel. The display panel may display an image using the panel power voltage.

The voltage generator may operate in either a low power mode or a normal mode according to a load current (i.e., panel current), wherein the operating mode is determined based on whether the load current exceeds a threshold current. For example, when the load current is smaller than the threshold current, the voltage generator may operate in the low power mode, and when the load current is greater than the threshold current, the voltage generator may operate in the normal mode. The low power mode may be a pulse skip mode (PSM). When the voltage generator operates in the pulse skip mode, the switching of switching elements included in the voltage generator may be skipped, thereby reducing overall switching frequency and lowering power consumption due to the switching of the switching elements.

By setting the threshold current to a greater value, a frequency of skipping the switching may be increased, and power consumption of the voltage generator may be further reduced. However, as the frequency of the skipping the switching of the switching elements increases, a ripple of the panel power voltage may also increase, causing fluctuations in image luminance of the display panel, and those fluctuations may be perceived as flicker. Consequently, the flicker occurring in the display image may deteriorate a display quality of the display device.

Accordingly, it may be important to control the threshold current so that occurrences of the flicker are suppressed in the image while minimizing the power consumption of the voltage generator.

### SUMMARY

Embodiments of the present inventive concept provide a display device for controlling a threshold current so that the display device reduces power consumption while suppressing flicker in a low power mode.

Embodiments of the present inventive concept provide an electronic device including the display device.

According to embodiments, a display device may include a display panel including a pixel circuit and a voltage generator configured to generate a panel power voltage based on an input voltage, and to supply the panel power voltage to the display panel. The voltage generator is configured to control an output level of the panel power voltage by switching its operation mode based on a magnitude of a load current relative to a threshold current. Where an absolute value of the panel power voltage is greater than an absolute value of a reference power voltage, as the absolute value of the panel power voltage decreases from a first absolute value to a second absolute value, the threshold current increases from a first threshold current to a second threshold current accordingly. Where the absolute value of the panel power voltage is lower than the absolute value of the reference power voltage, as the absolute value of the panel power voltage decreases from a third absolute value to a fourth absolute value, the threshold current increases from a third threshold current to a fourth threshold current. The voltage generator is configured to control the third threshold current at the third absolute value of the panel power voltage to be smaller than the second threshold current at the second absolute value of the panel power voltage.

In an embodiment, the voltage generator is configured to operate in a low power mode when the load current is smaller than the threshold current, and to operate in a normal mode when the load current is greater than the threshold current.

In an embodiment, a frequency of switching a switching element included in the voltage generator in the low power mode is lower than a frequency of switching the switching element in the normal mode.

In an embodiment, the absolute value of the panel power voltage is greater than the absolute value of the reference power voltage, the threshold current increases as the absolute value of the panel power voltage decreases, and, where the absolute value of the panel power voltage is lower than the absolute value of the reference power voltage, the threshold current increases as the absolute value of the panel power voltage decreases.

In an embodiment the voltage generator includes a first controller configured to control an output of the panel power voltage based on a pulse skip control signal an amplifier configured to output the pulse skip control signal based on a pulse skip reference voltage; and a second controller configured to control the pulse skip reference voltage based on the threshold current.

In an embodiment, the second controller may include a multiplexer configured to output a setting threshold current data or a reference threshold current data based on a selecting signal and a reference voltage generator configured to output the pulse skip reference voltage based on one of the setting threshold current data or the reference threshold current data.

In an embodiment, the second controller further includes a logic gate which outputs the selecting signal based on a reference power voltage data and a power voltage data.

In an embodiment, when the absolute value of the panel power voltage is lower than an absolute value of the reference power voltage, the power voltage data has a logic high level, and the selecting signal has a logic high level, such that the multiplexer outputs the reference threshold current data as the pulse skip reference voltage.

In an embodiment, when the absolute value of the panel power voltage is higher than an absolute value of the reference power voltage, the power voltage data has a logic low level, and the selecting signal has a logic low level, such that the multiplexer outputs the setting threshold current data as the pulse skip reference voltage.

In an embodiment, the multiplexer may include a first terminal receiving the setting threshold current data, a second terminal receiving the reference threshold current data, a third terminal receiving the selecting signal and an output terminal outputting one of the setting threshold current data or the reference threshold current data, wherein the logic gate includes a first terminal receiving the reference power voltage data, a second terminal receiving the power voltage data and an output terminal outputting the selecting signal.

In an embodiment, the logic gate is an AND gate configured to perform a logical AND operation between the reference power voltage data and the power voltage data.

According to embodiments, an electronic device may include a display panel including a pixel circuit, a display panel driver configured to control the display panel based on an input control signal, and a processor configured to output the input control signal. The display panel driver includes a voltage generator configured to apply a panel power voltage to the display panel based on an input voltage. The voltage generator is configured to control an output level of the panel power voltage by switching its operation mode based on a magnitude of a load current relative to a threshold current. When an absolute value of the panel power voltage is greater than an absolute value of a reference power voltage, as the absolute value of the panel power voltage decreases from a first absolute value to a second absolute value, the threshold current increases from a first threshold current to a second threshold current accordingly. When the absolute value of the panel power voltage is lower than the absolute value of the reference power voltage, as the absolute value of the panel power voltage decreases from a third absolute value to a fourth absolute value, the threshold current increases from a third threshold current to a fourth threshold current, The voltage generator is configured to control the third threshold current at the third absolute value of the panel power voltage to be smaller than the second threshold current at the second absolute value of the panel power voltage.

In an embodiment, the voltage generator is configured to operate in a low power mode when the load current is smaller than the threshold current, and to operate in a normal mode when the load current is greater than the threshold current, and, a frequency of switching a switching element included in the voltage generator in the low power mode is smaller than a frequency of switching the switching element in the normal mode.

In an embodiment, when the absolute value of the panel power voltage is greater than the absolute value of the reference power voltage, the threshold current increases as the absolute value of the panel power voltage decreases, and when the absolute value of the panel power voltage becomes lower than the reference power voltage, the threshold current instantaneously decreases, and when the absolute value of the panel power voltage is lower than an absolute value of the reference power voltage, the threshold current increases as the absolute value of the panel power voltage decreases.

In an embodiment, the voltage generator may include a first controller configured to control an output of the panel power voltage based on a pulse skip control signal, an amplifier configured to output the pulse skip control signal based on a pulse skip reference voltage and a second controller configured to control the pulse skip reference voltage based on the threshold current.

In an embodiment, the second controller includes a multiplexer configured to output one of a setting threshold current data or a reference threshold current data based on a selecting signal; and a reference voltage generator configured to generate the pulse skip reference voltage based on the output of the multiplexer.

In an embodiment, the second controller may further include a logic gate which outputs the selecting signal based on a reference power voltage data and a power voltage data.

In an embodiment, when the absolute value of the panel power voltage is lower than an absolute value of the reference power voltage, the power voltage data has a logic high level, and the selecting signal has a logic high level, such that the multiplexer outputs the reference threshold current data as the pulse skip reference voltage, wherein, when the absolute value of the panel power voltage is higher than an absolute value of the reference power voltage, the power voltage data has a logic low level, and the selecting signal has a logic low level, such that the multiplexer outputs the setting threshold current data as the pulse skip reference voltage.

A method for operating a display device comprises supplying, by a voltage generator, a panel power voltage to a display panel of the display device, controlling an output voltage of the voltage generator by switching its operation mode between a low power mode and a normal mode based on magnitude of a load current relative to a threshold current, wherein the voltage generator operates in a low power mode when the load current is smaller than the threshold current, and operates in a normal mode when the load current is greater than the threshold current, and in response to an absolute value of the panel power voltage becoming lower than a reference power voltage, decreasing the threshold current when absolute value of the panel power voltage becomes lower than a reference power voltage by selecting a reference threshold current data as a pulse skip reference voltage.

In the method, controlling the voltage generator to reduce a frequency of switching a switching element included in the voltage generator in the low power mode to be lower than a frequency of switching the switching element in the normal mode.

As described above, a voltage generator of a display device may operate in a low power mode or a normal mode based on magnitude of a load relative to a threshold current. In the low power mode, the voltage generator may control an output pulse of a second power voltage. Accordingly, a power consumption of the display device may be reduced.

Additionally, when an absolute value of the second power voltage is lower than an absolute value of a reference power voltage, the threshold current may be changed. For example, when the absolute value of the second power voltage is lower than the absolute value of the reference power voltage, the threshold current may decrease. When the absolute value of the second power voltage is lower than the absolute value of the reference power voltage, the threshold current may decrease, so that the voltage generator may operate in the normal mode when the load current is low. Accordingly, when the absolute value of the second power voltage decreases in the low power mode, the voltage generator may operate in the normal mode, and a ripple of the second power voltage may be reduced. Accordingly, occurrences of flicker on a display panel may be reduced. Accordingly, a display quality of the display panel may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present inventive concept.

FIG. 2 is a circuit diagram illustrating an example of a pixel circuit of FIG. 1.

FIG. 3 is a conceptual diagram illustrating a load current flowing in a display panel of FIG. 1.

FIG. 4 is a conceptual diagram illustrating an operation of a low power mode.

FIG. 5 is a conceptual diagram illustrating a voltage generator of FIG. 1 operating in a low power mode or in a normal mode depending on the load current of FIG. 3.

FIG. 6 is a conceptual diagram illustrating a pulse skip mode of a low power mode of FIG. 5 and a discontinuous conduction mode and a continuous conduction mode of a normal mode.

FIG. 7 is a block diagram illustrating a converter of a voltage generator included in a display device of FIG. 1.

FIG. 8 is a block diagram illustrating a second controller included in a converter of FIG. 7.

FIG. 9 is a table illustrating a setting threshold current data and a setting threshold current applied to a second controller of FIG. 8.

FIG. 10 is a graph illustrating a relationship between a second power voltage outputted by a voltage generator included in a display device of FIG. 1 and a threshold current.

FIG. 11 is a table illustrating an example of a relationship between the second power voltage outputted by a voltage generator of FIG. 1 and a threshold current.

FIG. 12 is a table illustrating an example of a relationship between the second power voltage outputted by a voltage generator of FIG. 1 and a threshold current.

FIG. 13 is a table illustrating an example of a relationship between the second power voltage outputted by a voltage generator of FIG. 1 and a threshold current.

FIG. 14 is a table illustrating an example of a relationship between the second power voltage outputted by a voltage generator of FIG. 1 and a threshold current.

FIG. 15 is a table illustrating an example of a relationship between the second power voltage outputted by a voltage generator of FIG. 1, a setting threshold current and a threshold current.

FIG. 16 is a graph illustrating a second power voltage in a comparative example.

FIG. 17 is a graph illustrating a second power voltage in the present embodiment.

FIG. 18 is a circuit diagram illustrating an example of a pixel circuit included in a display device of FIG. 1.

FIG. 19 is a circuit diagram illustrating an example of a pixel circuit included in a display device of FIG. 1.

FIG. 20 is a block diagram illustrating an electronic device according to embodiments of the present inventive concept.

FIGS. 21,22 and 23, are schematic diagrams illustrating an electronic device according to embodiments.

### DETAILED DESCRIPTION OF THE EMBODIMENTS

Hereinafter, the present inventive concept will be explained in detail with reference to the accompanying drawings.

It will be understood that, although the terms first, second, third etc. may be used herein to describe various elements, or levels of voltages or currents, these elements, or levels of voltages or currents should not be limited by these terms. Unless the context indicates otherwise, these terms are only used to distinguish one element, or one level of voltage or current from another element, or another level of voltage or current. Thus, a first element, or level discussed below in one section of the specification could be termed a second element, or level in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements or levels from each other.

A display device may include a display panel and a voltage generator supplying a panel power voltage to the display panel based on an input voltage. The voltage generator may control an output level of the panel power voltage by switching its operation mode between a low power mode and a normal mode based on a magnitude of a load current relative to a threshold current. The threshold current increases as an absolute value of the panel power voltage decreases. When an absolute value of the panel power voltage becomes lower than an absolute value of a reference power voltage, the threshold current instantaneously decrease to reduce threshold current difference between the low power mode and the normal mode, thereby suppressing occurrences of flicker on the display panel. Accordingly, a display quality of the display panel may be improved.

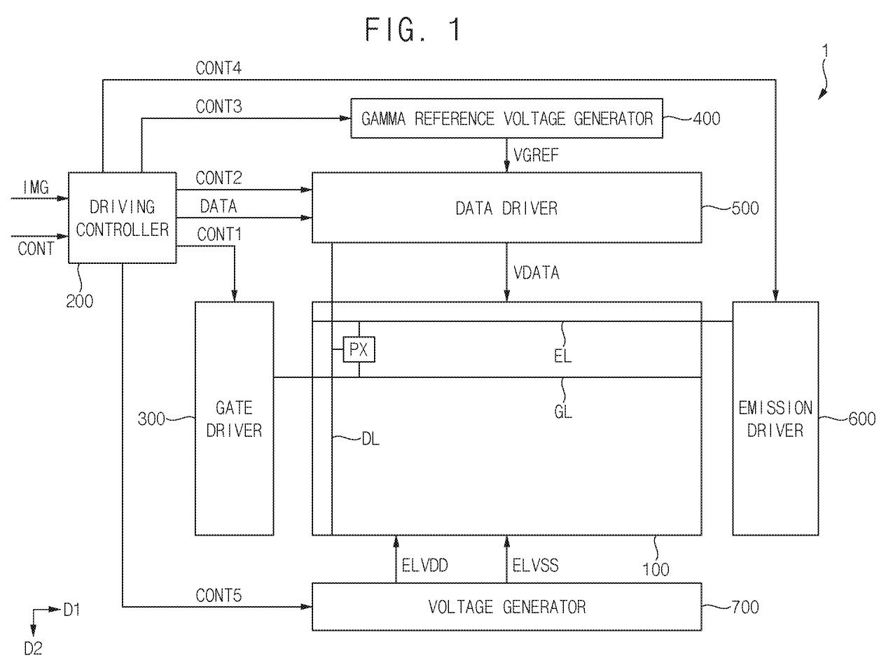

FIG. 1 is a block diagram illustrating a display device 1 according to embodiments of the present inventive concept.

Referring to FIG. 1, an embodiment of the display device 1 may include a display panel 100 and a display panel driver 110. The display panel driver may include a driving controller 200, a gate driver 300, a gamma reference voltage generator 400, a data driver 500, an emission driver 600 and a voltage generator 700.

The display panel 100 may include a display region on which an image is displayed and a peripheral region adjacent to the display region.

The display panel 100 may include a plurality of gate lines GL, a plurality of emission lines EL, a plurality of data lines DL and a plurality of pixels electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 may receive input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The driving controller 200 may generate the fifth control signal CONT5 for controlling an operation of the voltage generator 700 based on the input control signal CONT, and output the fifth control signal CONT5 to the voltage generator 700.

The gate driver 300 may generate gate signals driving the gate lines GL in response to the first control signal CONT1 received from the driving controller 200. The gate driver 300 may output the gate signals to the pixels of the display panel 100 through the gate lines GL.

In an embodiment, the gate driver 300 may be separately implemented and disposed in the peripheral region. Alternatively, the gate driver 300 may be integrated into a component disposed in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be integrated into the driving controller 200, or into the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into analog-type data voltages VDATA using the gamma reference voltages VGREF. The data driver 500 may output the data voltages VDATA to the pixels of the display panel 100 through the data lines DL.

In an embodiment, the data driver 500 may be separately implemented and disposed in the peripheral region. Alternatively, the data driver 500 may be integrated into a component disposed in the peripheral region.

The emission driver 600 may generate emission signal in response to the fourth control signal CONT4 received from the driving controller 200. The emission driver 600 may output the emission signal to the display panel 100.

In an embodiment, the emission driver 600 may be separately implemented and disposed in the peripheral region. Alternatively, the emission driver 600 may be integrated into a component disposed in the peripheral region.

Although FIG. 1 illustrates an embodiment where the gate driver 300 is disposed on a first side of the peripheral region adjacent to the display region of the display panel 100 and the emission driver 600 is disposed on a second side of the peripheral region adjacent to the display region of the display panel 100 for convenience of description, the invention is not limited thereto. In another embodiment, the gate driver 300 and the emission driver 600 may be disposed on the same side of the peripheral region of the display panel 100. Specifically, the gate driver 300 and the emission driver 600 may be disposed on opposite sides of the peripheral region of the display panel 100, and may be disposed on the same side of the peripheral region of the display panel 100. In an embodiment, for example, the gate driver 300 and the emission driver 600 may be integrally formed with each other as a single chip.

The voltage generator 700 may receive the fifth control signal CONT5 from the driving controller 200. The voltage generator 700 may receive an input voltage from an external apparatus in response to the fifth control signal CONT5. The voltage generator 700 may generate a panel power voltage ELVDD and ELVSS based on the input voltage. The voltage generator 700 may apply the panel power voltage ELVDD and ELVSS to the display panel 100. The input voltage may be in a range from 2.9V to 5V. For example, the input voltage may be about 5 V. For example, the input voltage may be about 4.0 V. For example, the input voltage may be about 2.9 V.

The voltage generator 700 may switch switching elements included in the voltage generator 700 to generate an inductor current, and may generate a panel power voltage ELVDD and ELVSS based on the inductor current. The panel power voltage ELVDD and ELVSS may include a first power voltage ELVDD and a second power voltage ELVSS. The first power voltage ELVDD may be higher than the second power voltage ELVSS. The first power voltage ELVDD may have a positive voltage value (e.g., 5V), and the second power voltage ELVSS may have a negative voltage value (e.g., -5V). The voltage generator 700 may adjust a voltage level of the second power voltage ELVSS to maintain stable luminance of the display panel 100. For example, when a luminance of the display panel 100 becomes lowered, the voltage generator 700 may increase an absolute value of the second power voltage ELVSS to increase light density of the pixels of the display panel 100. Conversely, when the luminance of the display panel 100 becomes high, the voltage generator 700 may decrease the absolute value of the second power voltage ELVSS to decrease light density of the pixels of the display panel 100.

In an embodiment, the voltage generator 700 may include a first converter and a second converter. The first converter may generate the first power voltage ELVDD based on the input voltage. The second converter may generate the second power voltage ELVSS based on the input voltage.

In an embodiment, the first converter may be a boost converter. When the first converter is the boost converter, the first converter may boost the input voltage to generate the first power voltage ELVDD.

In an embodiment, the second converter may be an inverting buck-boost converter. The inverting buck-boost converter, as the second converter, may generate the second power voltage ELVSS from the input voltage by switching a switching element included in the inverting buck-boost converter. When the switching element is turned on, energy may be accumulated in an inductor, thereafter, when the switching element is turned off, the stored energy is transferred to output node (e.g., the second power voltage ELVSS), thereby generating a regulated negative output voltage.

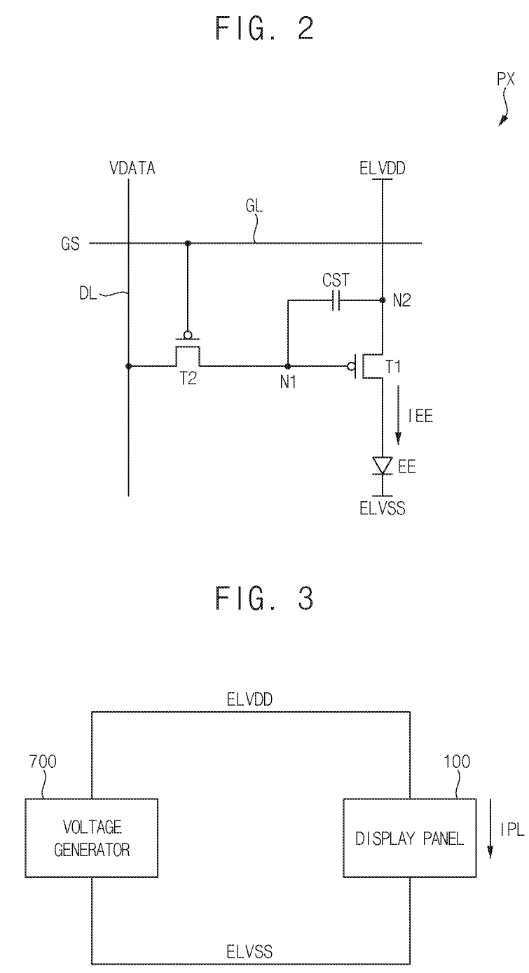

FIG. 2 is a circuit diagram illustrating an example of a pixel circuit PX of FIG. 1. FIG. 3 is a conceptual diagram illustrating a load current IPL flowing in a display panel 100 of FIG. 1.

Referring to FIGS. 1-3 , the pixel circuit PX may include a first transistor T1, a second transistor T2, a storage capacitor CST and a light emitting element EE.

The first transistor T1 may include a control electrode connected to a first node N1, a first electrode receiving the first power voltage ELVDD and a second electrode connected to a first electrode of the light emitting element EE. The first transistor T1 may drive a driving current IEE based on the difference between a voltage of the control electrode and a voltage of the first electrode.

The second transistor T2 may include a control electrode connected to the gate line GL to receive a gate signal GS, a first electrode connected to a data line DL to receive data voltage VDATA and a second electrode connected to the first node N1. The second transistor T2 may transfer the data voltage VDATA to the first node N1 in response to the gate signal GS.

The storage capacitor CST may include a first electrode receiving the first power voltage ELVDD and a second electrode connected to the first node N1. The storage capacitor CST may store the data voltage VDATA.

The light emitting element EE may include the first electrode connected to the second electrode of the first transistor T1 and a second electrode receiving the second power voltage ELVSS. The light emitting element EE may emit light based on the driving current IEE. The luminance of an image may be determined based on magnitude of the driving current IEE.

As shown in FIG. 2, the first transistor T1 and the second transistor T2 may be implemented as positive-type (P-type) transistors, but the present inventive concept is not limited thereto. The first transistor T1 and the second transistor T2 may alternatively be implemented as negative-type (N-type) transistors. Although FIG. 2 illustrates the pixel including two transistors T1 and T2 and one capacitor CST, the present inventive concept is not limited thereto. The pixel circuit PX may include three or more transistors and/or two or more capacitors.

As shown in FIG. 2, the pixel circuit PX may generate the driving current IEE flowing between the first power voltage ELVDD and the second power voltage EVLSS. As shown in FIG. 3, the display panel 100 may include pixel circuits PX and may generate a panel current flowing between the first power voltage ELVDD and the second power voltage EVLSS. The panel current may be referred to as a load current. In this regard, the driving current IEE may correspond to a per-pixel value, whereas the load current IPL may corresponds to a per-panel value.

Depending on a size of the display panel 100, the load current IPL corresponding to a same grayscale level may vary. For example, at a 10-grayscale level, the driving current IEE may be uniform across pixel circuits PX. However, as the number of pixel circuits PX varies with the size of the display panel 100, overall load current IPL may also vary accordingly.

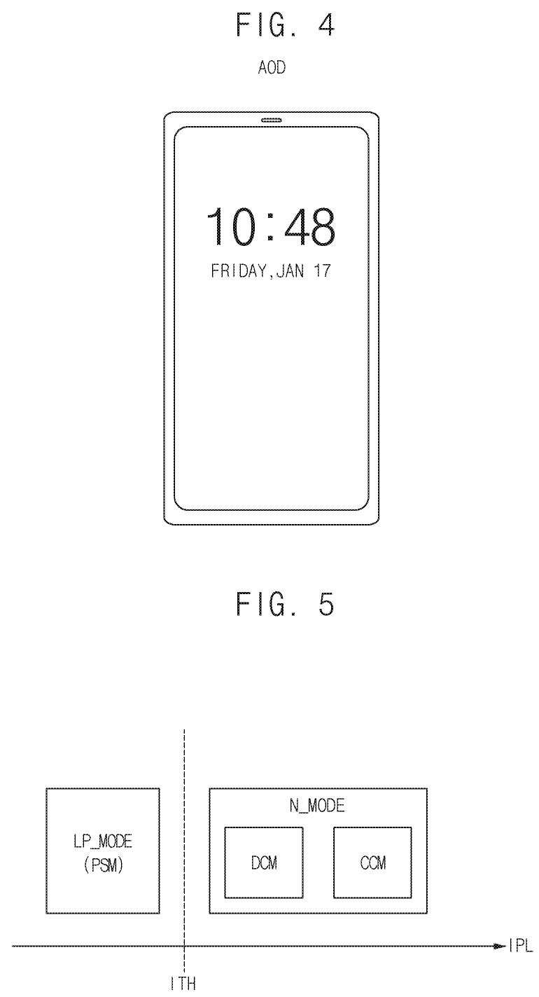

FIG. 4 is a conceptual diagram illustrating an operation of a low power mode.

Referring to FIGS. 1-4 , the display device 1 may operate in an always-on display AOD mode, in which the display panel 100 displays a time image, a date image, or the like, even during a standby or sleep state.

Since the display device 1 operates in a low grayscale and/or a low luminance in the always-on display AOD mode, the display device 1 may require a low power in the always-on display AOD mode. Therefore, the voltage generator 700 may operate in a normal mode or a low power mode. The voltage generator 700 may reduce power consumption by operating in the low power mode. Hereinafter, the normal mode may be designated as a first mode and the low power mode may be designated as a second mode.

Although FIG. 4 illustrates only the always-on display AOD mode as an example in which the voltage generator 700 operates in the low power mode, the present inventive concept is not limited thereto. The low power mode of the voltage generator 700 may be applied in various embodiments where the display device 1 is required to reduce power consumption. However, for a convenience of an explanation, the always-on display mode AOD will be described as an example where the display device 1 is required to reduce power consumption. Additionally, the voltage generator 700 according to the embodiments of the present inventive concept may be applied to both the first converter and the second converter, but for the convenience of the explanation, the second converter of the voltage generator 700 operating in the low power mode will be described.

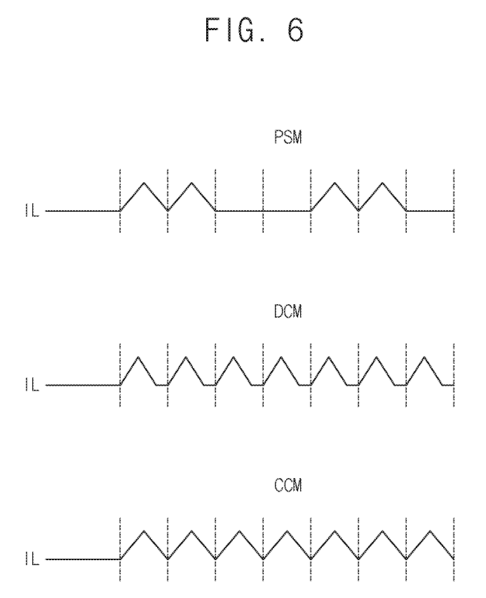

FIG. 5 is a conceptual diagram illustrating a voltage generator 700 of FIG. 1 operating in a low power mode LP_MODE and a normal mode N_MODE depending on magnitude of the load current IPL of FIG. 3. The low power mode LP_MODE may include a pulse skip mode PSM, and the normal mode N_MODE may include a discontinuous conduction mode DCM and a continuous conduction mode CCM. FIG. 6 is a conceptual diagram illustrating a waveform of the inductor current IL at the pulse skip mode PSM of the low power mode LP_MODE of FIG. 5 and waveforms of the inductor currents IL at the discontinuous conduction mode DCM and at the continuous conduction mode CCM of the normal mode N_MODE.

Referring to FIGS. 1-6 , the voltage generator 700 may generate the second power voltage ELVSS using the input voltage, and the display panel 100 may generate the load current IPL using the second power voltage ELVSS.

When the display device 1 operates in the always-on display mode AOD, the display device 1 may operate at the low grayscale level and/or a low luminance, resulting in a decreased load current IPL. In this case, the operating mode of the voltage generator 700 may be determined based on a magnitude of the load current IPL relative to a threshold current ITH, in which the threshold current ITH may be a reference for the determination.

For example, the operating mode of the voltage generator 700 may be switched between the normal mode N_MODE and the low power mode LP_MODE based on magnitude of the load current IPL relative to a threshold current ITH. When the load current IPL is smaller than the threshold current ITH, the voltage generator 700 may operate in the low power mode LP_MODE. When the load current IPL is greater than or equal to the threshold current ITH, the voltage generator 700 may operate in the normal mode N_MODE.

In an embodiment, the low power mode may be a pulse skip mode PSM, and the normal mode may be a discontinuous conduction mode DCM or a continuous conduction mode CCM.

While operating in the pulse skip mode PSM, the voltage generator 700 may skip the switching of the switching elements included in the voltage generator 700 intermittently. Accordingly, during certain periods of the pulse skip mode PSM, the inductor current IL may not be generated, and thus may not include a pulse-shaped waveform during those periods. As a result, in the pulse skip mode PSM, the waveform of the inductor current IL may intermittently omit pulse-shaped waveforms, thereby reducing a number of pulses in the pulse-shaped waveforms. In contrast, in the discontinuous conduction mode DCM or the continuous conduction mode CCM, the waveform of the inductor current may continuously include pulse-shaped waveforms.

In the discontinuous conduction mode DCM, although the switching of the switching elements included in the voltage generator 700 is not skipped, the inductor current IL may discontinuously increase and decrease.

In the continuous conduction mode CCM, the switching of the switching elements included in the voltage generator 700 is not skipped, and thus the inductor current IL may continuously increase and decrease.

A power consumption of the voltage generator 700 in the pulse skip mode PSM may be less than a power consumption of the voltage generator 700 in the discontinuous conduction mode DCM. A power consumption of the voltage generator 700 in the discontinuous conduction mode DCM may be less than a power consumption of the voltage generator 700 in the continuous conduction mode CCM.

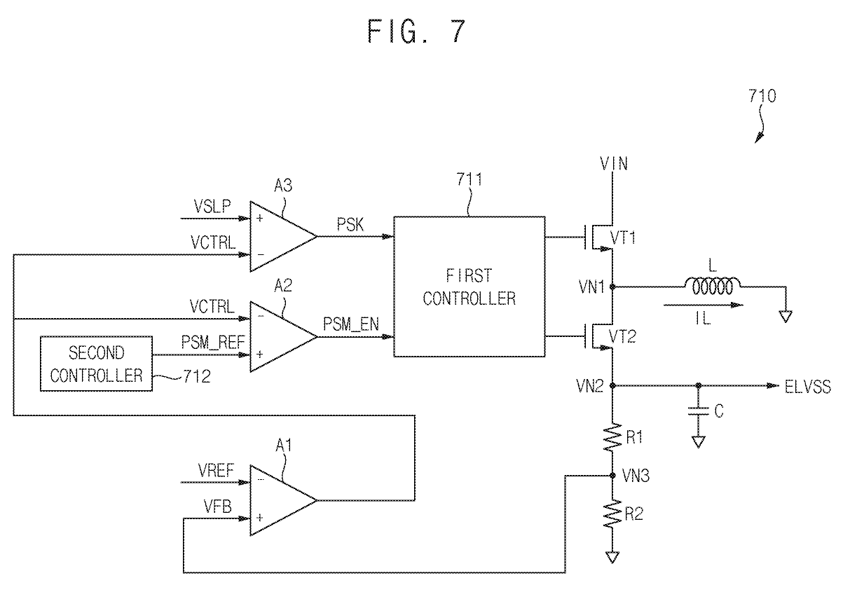

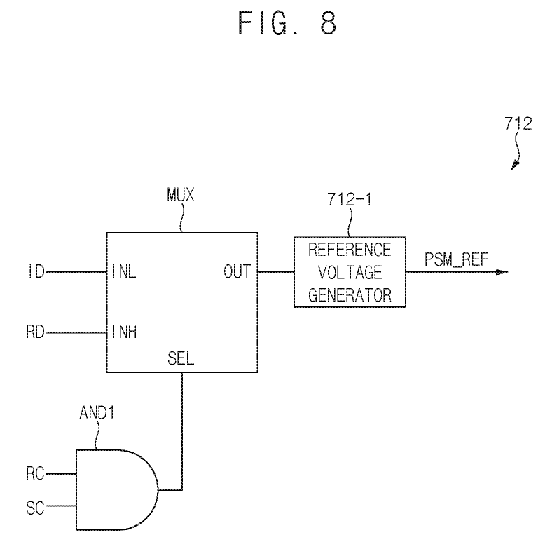

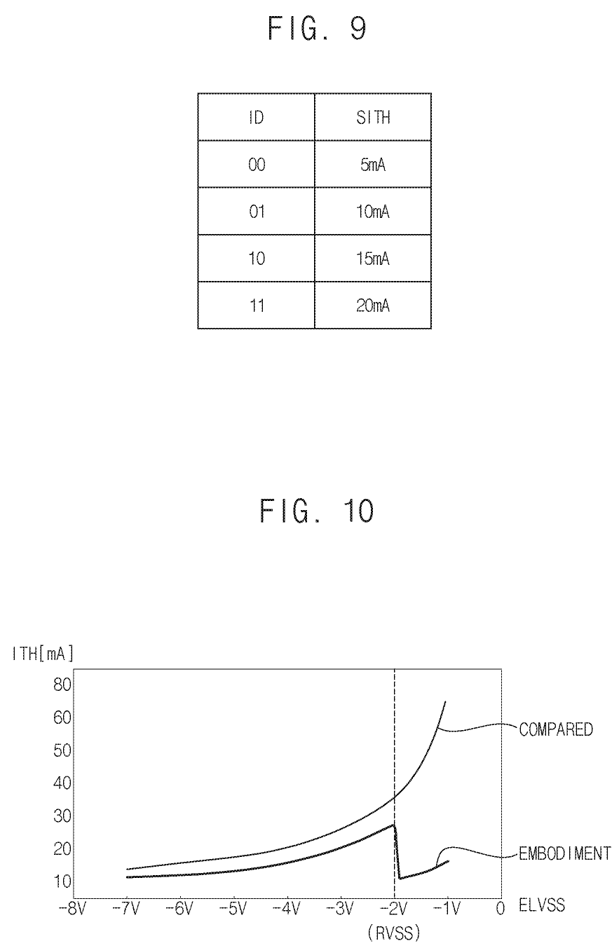

FIG. 7 is a block diagram illustrating an example of a converter 710 of a voltage generator 700 included in a display device 1 of FIG. 1. FIG. 8 is a block diagram illustrating an example of a second controller 712 included in a converter 710 of FIG. 7. FIG. 9 is a table illustrating a setting threshold current data ID and a setting threshold current SITH applied to a second controller 712 of FIG. 8. FIG. 10 is a graph illustrating a relationship between a second power voltage ELVSS generated by a voltage generator 700 of a display device 1 of FIG. 1 and a threshold current ITH.

Referring to FIGS. 1-10 , a converter 710 may receive the input voltage VIN. The converter 710 may generate the second power voltage ELVSS using the input voltage VIN. The converter 710 may operate selectively in the low power mode LP_MODE or the normal mode N_MODE depending on a magnitude of the load current IPL relative to the threshold current ITH, in which the threshold current ITH may be a reference for the selection.

The converter 710 may include a first controller 711, a second controller 712, a first amplifier A1, a second amplifier A2, a third amplifier A3, a first switching element VT1, a second switching element VT2, an inductor L, a capacitor C, a first resistor R1 and a second resistor R2.

The first controller 711 may switch the first switching element VT1 and the second switching element VT2 in response to a pulse skip control signal PSM_EN and a skip signal PSK, thereby controlling an output level of the second power voltage ELVSS. The voltage generator 700 may operate in the low power mode in response to an activation level of the pulse skip control signal, and may operate in the normal mode in response to an inactivation level of the pulse skip control signal PSM_EN. The first controller 711 may turn-on or turn-off the first switching element VT1, thereby controlling a turn-on period of the first switching element VT1. The first controller 711 may turn-on or turn-off the second switching element VT2, thereby controlling a turn-on period of the second switching element VT2. The first controller 711 may alternately turn on the first switching element VT1 and the second switching element VT2.

The first switching element VT1 may include a control electrode connected to the first controller 711, a first electrode receiving the input voltage VIN and a second electrode connected to a first node VN1. The second switching element VT2 may include a control electrode connected to the first controller 711, a first electrode connected to the first node VN1 and a second electrode connected to a second node VN2 which is output node of the second power voltage ELVSS. The inductor L may include a first terminal connected to the first node VN1 and a second terminal connected to a ground voltage. The capacitor C may include a first terminal connected to the second node VN2 and a second terminal connected to the ground voltage.

As illustrated in FIG. 7, the first switching element VT1 and the second switching element VT2 may be implemented as N-type transistors, but the present inventive concept is not limited thereto. The first switching element VT1 and the second switching element VT2 may be implemented as P-type transistors.

When the first switching element VT1 is turned on and the second switching element VT2 is turned off, an inductor current IL may flow through the inductor L As a result, an electromotive force may be induced around the inductor L due to the inductor current IL. Subsequently, when the first switching element VT1 is turned off and the second switching element VT2 is turned on, the electromotive force energy stored in the inductor is transferred to second node VN2 (i.e., output node of the second power voltage ELVSS) in opposite voltage polarity, thereby converting the input voltage VIN into the second power voltage ELVSS.

The first resistor R1 may include a first terminal connected to the second node VN2 and a second terminal connected to a third node VN3. The second resistor R2 may include a first terminal connected to the third node VN3 and a second terminal connected to the ground voltage. In an embodiment, a feedback reference voltage may be output from the second terminal of the first resistor R1. The feedback voltage VFB may have a value between the ground voltage and the second power voltage ELVSS.

The first amplifier A1 may include a first input terminal for receiving the feedback voltage VFB, a second input terminal for receiving a reference voltage VREF and an output terminal for outputting a control voltage VCTRL. The first amplifier A1 may generate the control voltage VCTRL by amplifying a voltage difference between the feedback voltage VFB and the reference voltage VREF. Since the control voltage VCTRL is generated based on the second power voltage ELVSS, the control voltage VCTRL may reflect variation of the second power voltage ELVSS.

The second amplifier A2 may include a first input terminal for receiving a pulse skip reference voltage PSM_REF, a second input terminal for receiving the control voltage VCTRL and an output terminal for outputting the pulse skip control signal PSM_EN. The second amplifier A2 may compare the pulse skip reference voltage PSM_REF with the control voltage VCTRL, and amplify the difference between the pulse skip reference voltage PSM_REF and the control voltage VCTRL, thereby outputting the pulse skip control signal PSM_EN. In this respect, the second amplifier A2 may be regarded as a comparator.

The third amplifier A3 may include a first input terminal for receiving a summation voltage VSLP, a second input terminal for receiving the control voltage VCTRL and an output terminal for outputting the skip signal PSK. The third amplifier A3 may compare the summation voltage VSLP with the control voltage VCTRL to generate the skip signal PSK. The summation voltage VSLP may be generated based on the inductor current IL, and thus reflect variation of the inductor current IL.

The second controller 712 may output the pulse skip reference voltage PSM_REF.

Referring to FIG. 8, the second controller 712 may include a multiplexer MUX, a logic gate AND1 and a reference voltage generator 712-1.

The multiplexer MUX may include a first input terminal INL receiving the setting threshold current data ID, a second input terminal INH receiving the reference threshold current data RD, a third input terminal receiving a selecting signal SEL and an output terminal for outputting one of the setting threshold current data ID and the reference threshold current data RD. The multiplexer MUX may output one of the setting threshold current data ID or the reference threshold current data RD based on the selecting signal SEL. For example, when the selecting signal SEL has a logic high level, the multiplexer MUX may output the reference threshold current data RD, and when the selecting signal SEL has a logic low level, the multiplexer MUX may output the setting threshold current data ID.

Referring to FIG. 9, the setting threshold current data ID may be data representing a setting threshold current SITH. The setting threshold current SITH may serve as a reference value for the threshold current ITH at various levels of the second power voltage ELVSS. For example, the setting threshold current SITH may be set to 5 mA. When the second power voltage ELVSS is about -4 V, the setting threshold current SITH may be a reference with which the threshold current ITH is determined. When the threshold current ITH is lower than 5mA, the voltage generator may operate in the low power mode. Subsequently, when the second power voltage ELVSS may change to about -3 V, the threshold current ITH increases and become greater than 5 mA. Accordingly, the operating mode of the voltage generator may be changed to the normal mode. In another case, the setting threshold current SITH may be set to 20 mA. When the threshold current ITH is lower than 20 mA at -3V of the second power voltage ELVSS, the voltage generator may operate in the low power mode at -3V of the second power voltage ELVSS. Subsequently, when the second power voltage ELVSS changes to about -1 V, the threshold current ITH may increase to about 100 mA, which is greater than 20 mA of the setting threshold current SITH, and the voltage generator may change its operating mode to the normal mode, and thus the threshold current ITH may be reduced to below 20 mA at -1V of the second power voltage ELVSS. Because of the large differences between the threshold current ITH of the lower power mode and the threshold current ITH of the normal mode at -1V of the second power voltage ELVSS, flicker may occur in the display image of the display panel 100. In another case, the setting threshold current SITH is about 5 mA. When the second power voltage ELVSS is about -4 V, the setting threshold current SITH may be a reference with which the threshold current ITH is determined. When the threshold current ITH is greater than 5mA, the voltage generator may operate in the normal mode. Subsequently, when the second power voltage ELVSS changes to about -5 V, the threshold current ITH may decrease and become less than about 5 mA, which is smaller the setting threshold current SITH, and the voltage generator may change its operating mode to the low power mode at -5V of the second power voltage ELVSS. As the threshold current ITH may be changed based on an absolute value of the second power voltage ELVSS, the setting threshold current SITH may be set differently based on the setting threshold current data ID. For example, when the setting threshold current data ID is 00, the setting threshold current SITH may be set to about 5 mA. When the setting threshold current data ID is 01, the setting threshold current SITH may be set to about 10 mA. When the setting threshold current data ID is 10, the setting threshold current SITH may be set to about 15 mA. When the setting threshold current data ID is 11, the setting threshold current SITH may be set to about 20 mA. The setting threshold current SITH may be determined as a balancing between reducing power consumption and minimizing occurrences of flicker, in consideration of the fact that when the absolute value of the second power voltage ELVSS increases, the threshold current ITH decreases, and when the absolute value of the second power voltage ELVSS decreases, the threshold current ITH increases.

The reference threshold current data RD may be data set by the user. The reference threshold current data RD may be one of the setting threshold current data ID. For example, the user may set the reference threshold current data RD to 5 mA by selecting one of the setting threshold current data ID corresponding to 5 mA among the different values of the setting threshold current SITH.

Referring to FIG. 8, the logic gate AND1 may include a first input terminal for receiving reference power voltage data RC, a second input terminal for receiving power voltage data SC and an output terminal for outputting the selection signal SEL. The logic gate AND1 may output the selection signal SEL based on the reference power voltage data RC and the power voltage data SC. In an embodiment, the logic gate AND1 may be an AND gate. When the logic gate AND1 is an AND gate, the logic gate AND1 may perform a logical AND operation on the reference power voltage data RC and the power voltage data SC.

The reference power voltage data RC may include information about a reference power voltage RVSS. In an embodiment, the reference power voltage data RC may be set to a logic high level for enabling the second controller 712 to generate the pulse skip reference voltage PSM_REF.

The power voltage data SC may include information about the second power voltage ELVSS. For example, when the absolute value of the second power voltage ELVSS is lower than the reference power voltage RVSS, the power voltage data SC may have a logic high level. Accordingly, when the absolute value of the second power voltage ELVSS is lower than the reference power voltage RVSS, the logic gate AND1 may output the selection signal SEL having a logic high level. For example, when the absolute value of the second power voltage ELVSS is equal to or higher than the reference power supply voltage RVSS, the power voltage data SC may have a logic low level. Accordingly, when the absolute value of the second power voltage ELVSS is equal to or higher than the reference power voltage RVSS, the logic gate AND1 may output the selection signal SEL having a logic low level.

The reference voltage generator 712-1 may output the pulse skip reference voltage PSM_REF corresponding to one of the setting threshold current data ID or the reference threshold current data RD, which is selected by the multiplexer MUX. For example, the pulse skip reference voltage PSM_REF may include data codes corresponding to a voltage level with which the threshold current ITH is determined.

Referring to FIG. 10, according to a comparative example, the threshold current ITH may increase as the absolute value of the second power voltage ELVSS decreases. In contrast, according to the present embodiment, the threshold current ITH may increase as the absolute value of the second power voltage ELVSS decreases when the absolute value of the second power voltage ELVSS is greater than the absolute value of the reference power voltage RVSS. However, when the absolute value of the second power voltage ELVSS is lowered to the absolute value of the reference power voltage RVSS, the threshold current ITH may instantaneously decrease at the reference power voltage RVSS, and then increase again as the absolute value of the second power voltage ELVSS further decreases.

In the present embodiment, the voltage generator 700 may operate in the low power mode or the normal mode based on magnitude of the load current IPL relative to the threshold current ITH. In the low power mode, the voltage generator 700 may extend skip pulse period while generating the second power voltage ELVSS by setting the SITH to relatively high value (e.g., 20mV), thereby reducing overall switching frequency of the switching element. Accordingly, a power consumption of the display device 1 may be reduced.

When the absolute value of the second power voltage ELVSS is lowered to the absolute value of the reference power voltage RVSS, the threshold current ITH may change in an opposite direction. For example, when the absolute value of the second power voltage ELVSS becomes lower than the absolute value of the reference power voltage RVSS, the threshold current ITH may instantaneously decrease. Because the threshold current ITH may instantaneously decrease when the absolute value of the second power voltage ELVSS is lowered to the absolute value of the reference power voltage RVSS, the voltage generator 700 may change its operation mode from the low power mode to the normal mode. As the voltage generator 700 may change its operation mode from the low power mode to the normal mode at lower threshold current ITH in a region when the absolute value of the second power voltage ELVSS is below the absolute value of the reference power voltage RVSS, a ripple of the second power voltage ELVSS may be reduced. Accordingly, occurrences of flicker on the display panel 100 may be reduced, thereby improving a display quality of the display panel 100.

FIG. 11 is a table illustrating an example of a relationship between the second power voltage ELVSS outputted by a voltage generator 700 of FIG. 1 and a threshold current ITH.

Referring to FIGS. 1-11 , each value of the threshold current ITH may indicate a load current at which operation modes of the voltage generator 700 changes between the low power mode and the normal mode at the corresponding second power voltage ELVSS. For example, when the setting threshold current SITH is set to a first setting threshold current (e.g., 5 mA), the threshold current ITH may have a first threshold current I1A at a first voltage level VSS1. The first voltage level VSS1 may be about -7 V. The threshold current ITH may have a second threshold current I2A at a second voltage level VSS2 of the second power voltage ELVSS. The second voltage level VSS2 may be about -6 V. The second threshold current I2A may be greater than the first threshold current I1A. The threshold current ITH may have a third threshold current I3A at a third voltage level VSS3 of the second power voltage ELVSS. The third voltage level VSS3 may be about -5 V. The third threshold current I3A may be greater than the second threshold current I2A. The threshold current ITH may have a fourth threshold current I4A at a fourth voltage level VSS4 of the second power voltage ELVSS. The fourth voltage level VSS4 may be about -4 V. The fourth threshold current I4A may be greater than the third threshold current I3A. The threshold current ITH may have a fifth threshold current I5A at a fifth voltage level VSS5 of the second power voltage ELVSS. The fifth voltage level VSS5 may be about -3 V. The fifth threshold current I5A may be greater than the fourth threshold current I4A. The threshold current ITH may have a sixth threshold current I6A at a sixth voltage level VSS6 of the second power voltage ELVSS. The sixth voltage level VSS6 may be about -2 V. The sixth threshold current I6A may be greater than the fifth threshold current I5A. The threshold current ITH may have a seventh threshold current I7A at a seventh voltage level VSS7 of the second power voltage ELVSS. The seventh voltage level VSS7 may be about -1 V. The seventh threshold current I7A may be greater than the sixth threshold current I6A.

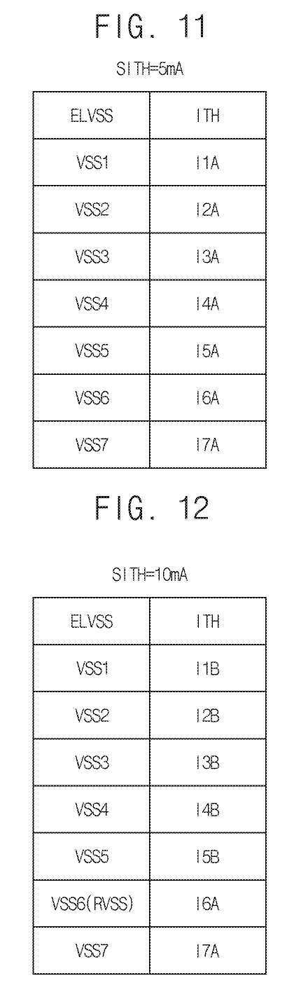

FIG. 12 is a table illustrating an example of a relationship between the second power voltage ELVSS outputted by a voltage generator 700 of FIG. 1 and a threshold current ITH.

Referring to FIGS. 1-12, when the setting threshold current SITH is set to a second setting threshold current (e.g.,10 mA), the threshold current ITH may have a first threshold current I1B at the first voltage level VSS1 of the second power voltage ELVSS. The threshold current ITH may have a second threshold current I2B at the second voltage level VSS2 of the second power voltage ELVSS. The second threshold current I2B may be greater than the first threshold current I1B. The threshold current ITH may have the third threshold current I3B at the third voltage level VSS3 of the second power voltage ELVSS. The third threshold current I3B may be greater than the second threshold current I2B. The threshold current ITH may have a fourth threshold current I4B at the fourth voltage level VSS4 of the second power voltage ELVSS. The fourth threshold current I4B may be greater than the third threshold current I3B. The threshold current ITH may have a fifth threshold current I5B at the fifth voltage level VSS5 of the second power voltage ELVSS. The fifth threshold current I5B may be greater than the fourth threshold current I4B. The threshold current ITH may have the sixth threshold current I6A corresponding to the first setting threshold current at the sixth voltage level VSS6 of the second power voltage ELVSS. The sixth voltage level VSS6 of the second power voltage ELVSS may be the reference power voltage RVSS. Therefore, the sixth threshold current may be determined by selecting the setting threshold current SITH from the reference threshold current data RD rather than from one of the setting threshold current data ID of FIG. 8. When the reference threshold current data RD is set to 5mA which correspond to the first setting threshold current, the threshold current ITH may have the sixth threshold current I6A of the first setting threshold current. The sixth threshold current I6A may be smaller than the fifth threshold current I5B. The threshold current ITH may have the seventh threshold current I7A of the first setting threshold current at the seventh voltage level VSS7 of the second power voltage ELVSS. The seventh threshold current I7A may be larger than the sixth threshold current I6A.

In the present embodiment, when the absolute value of the second power voltage ELVSS is lower than the absolute value of the reference power voltage RVSS, the threshold current ITH may change accordingly. For example, when the absolute value of the second power voltage ELVSS becomes lower than the absolute value of the reference power voltage RVSS, the threshold current ITH may instantaneously decrease. When the absolute value of the second power voltage ELVSS becomes lower than the absolute value of the reference power voltage RVSS, the threshold current ITH may instantaneously decrease, so that the voltage generator 700 may operate in the normal mode even when the load current IPL is low. Accordingly, when the absolute value of the second power voltage ELVSS decreases in the low power mode, the voltage generator 700 may operate in the normal mode, and a ripple of the second power voltage ELVSS may be reduced. Accordingly, occurrences of flicker on the display panel 100 may be reduced, thereby improving a display quality of the display panel 100.

FIG. 13 is a table illustrating an example of a relationship between the second power voltage ELVSS outputted by a voltage generator 700 of FIG. 1 and a threshold current ITH.

Referring to FIGS. 1-11 and 13, when the setting threshold current SITH is set to a third setting threshold current (e.g., 15 mA), the threshold current ITH may have a first threshold current I1C at the first voltage level VSS1 of the second power voltage ELVSS. The threshold current ITH may have a second threshold current I2C at the second voltage level VSS2 of the second power voltage ELVSS. The second threshold current I2C may be greater than the first threshold current I1C. The threshold current ITH may have a third threshold current I3C at the third voltage level VSS3 of the second power voltage ELVSS. The third threshold current I3C may be greater than the second threshold current I2C. The threshold current ITH may have a fourth threshold current I4C at the fourth voltage level VSS4 of the second power voltage ELVSS. The fourth threshold current I4C may be greater than the third threshold current I3C. The threshold current ITH may have a fifth threshold current I5C at the fifth voltage level VSS5 of the second power voltage ELVSS. The fifth threshold current I5C may be greater than the fourth threshold current I4C. The sixth voltage level VSS6 may be the reference power voltage RVSS. The threshold current ITH may have the sixth threshold current I6A corresponding to the first setting threshold current at the sixth voltage level VSS6 of the second power voltage ELVSS. The sixth voltage level VSS6 of the second power voltage ELVSS may be the reference power voltage RVSS. Therefore, the sixth threshold current may be determined by selecting the setting threshold current SITH from the reference threshold current data RD rather than from one of the setting threshold current data ID of FIG. 8. When the reference threshold current data RD is set to 5mA which correspond to the first setting threshold current, the threshold current ITH may have the sixth threshold current I6A corresponding to the first setting threshold current. The sixth threshold current I6A may be smaller than the fifth threshold current I5C. The threshold current ITH may have the seventh threshold current I7A of the first setting threshold current at the seventh voltage level VSS7 of the second power voltage ELVSS. The seventh threshold current I7A may be larger than the sixth threshold current I6A.

In the present embodiment, when the absolute value of the second power voltage ELVSS is lower than the absolute value of the reference power voltage RVSS, the threshold current ITH may change accordingly. For example, when the absolute value of the second power voltage ELVSS becomes lower than the absolute value of the reference power voltage RVSS, the threshold current ITH may instantaneously decrease. When the absolute value of the second power voltage ELVSS becomes lower than the absolute value of the reference power voltage RVSS, the threshold current ITH may instantaneously decrease, so that the voltage generator 700 may operate in the normal mode even when the load IPL is low. Accordingly, when the absolute value of the second power voltage ELVSS decreases in the low power mode the voltage generator 700 may operate in the normal mode, and a ripple of the second power voltage ELVSS may be reduced. Accordingly, occurrences of flicker on the display panel 100 may be reduced thereby, improving a display quality of the display panel 100.

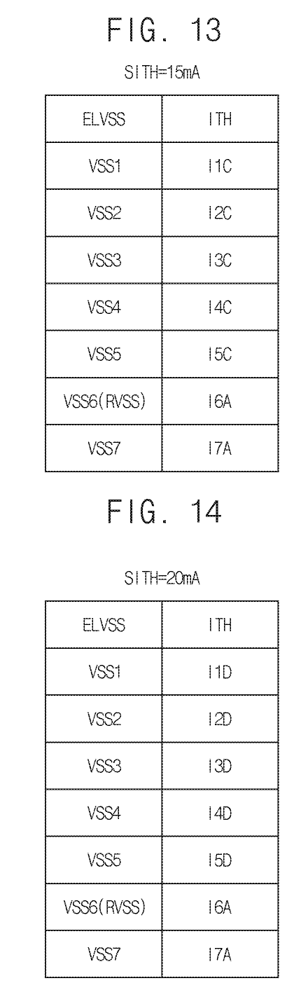

FIG. 14 is a table illustrating an example of a relationship between the second power voltage ELVSS outputted by a voltage generator 700 of FIG. 1 and a threshold current ITH.

Referring to FIGS. 1-11 and 14 , when the setting threshold current SITH is set to a fourth setting threshold current (e.g., 20 mA), the threshold current ITH may have a first threshold current I1D at the first voltage level VSS1 of the second power voltage ELVSS. The threshold current ITH may have a second threshold current I2D at the second voltage level VSS2 of the second power voltage ELVSS. The second threshold current I2D may be greater than the first threshold current I1D. The threshold current ITH may have a third threshold current I3D at the third voltage level VSS3 of the second power voltage ELVSS. The third threshold current I3D may be greater than the second threshold current I2D. The threshold current ITH may have a fourth threshold current I4D at the fourth voltage level VSS4 of the second power voltage ELVSS. The fourth threshold current I4D may be greater than the third threshold current I3D. The threshold current ITH may have a fifth threshold current I5D at the fifth voltage level VSS5 of the second power voltage ELVSS. The fifth threshold current I5D may be greater than the fourth threshold current I4D. The sixth voltage level VSS6 may be the reference power voltage RVSS. The threshold current ITH may have the sixth threshold current I6A corresponding to the first setting threshold current at the sixth voltage level VSS6 of the second power voltage ELVSS. The sixth voltage level VSS6 of the second power voltage ELVSS may be the reference power voltage RVSS. Therefore, the sixth threshold current may be determined by selecting the setting threshold current SITH from the reference threshold current data RD rather than from one of the setting threshold current data ID of FIG. 8. When the reference threshold current data RD is set to 5mA which correspond to the first setting threshold current, the threshold current ITH may have the sixth threshold current I6A corresponding to the first setting threshold current. The sixth threshold current I6A may be smaller than the fifth threshold current I5D. The threshold current ITH may have the seventh threshold current I7A of the first setting threshold current at the seventh voltage level VSS7 of the second power voltage ELVSS. The seventh threshold current I7A may be larger than the sixth threshold current I6A.

In the present embodiment, when the absolute value of the second power voltage ELVSS is lower than the absolute value of the reference power voltage RVSS, the threshold current ITH may change accordingly. For example, when the absolute value of the second power voltage ELVSS becomes lower than the absolute value of the reference power voltage RVSS, the threshold current ITH may instantaneously decrease. When the absolute value of the second power voltage ELVSS becomes lower than the absolute value of the reference power voltage RVSS, the threshold current ITH may instantaneously decrease, so that the voltage generator 700 may operate in the normal mode even when the load IPL is low. For example, when the setting threshold current SITH is set to 20 mA, the threshold current ITH may reach up to 100 mA while operating in the low power mode at the reference power voltage RVSS (e.g., -2V). As the operating mode is changed to the normal mode, the threshold current ITH may be changed to below 30mA. Because of the abrupt change in the threshold current ITH at or below the reference power voltage RVSS, the luminance of the display panel may change abruptly, thereby perceived as a flicker while displaying image on the display panel. By selecting the reference threshold current data RD instead of one of the setting threshold current data ID at or below the reference power voltage RVSS, the threshold current difference between the low power mode and the normal mode may be reduced. Accordingly, when the absolute value of the second power voltage ELVSS decreases in the low power mode, the voltage generator 700 may change its operation mode to the normal mode at lower level of the threshold current ITH, and a ripple of the second power voltage ELVSS may be reduced. Accordingly, occurrences of the flicker on the display panel 100 may be reduced, thereby improving a display quality of the display panel 100.

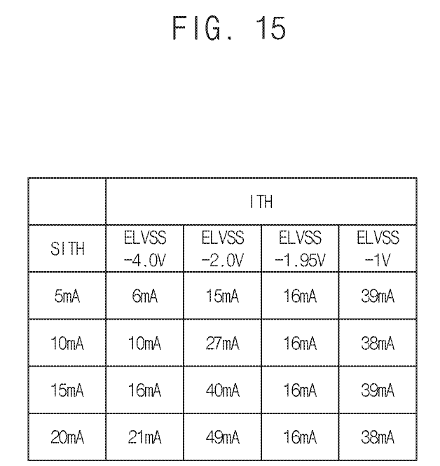

FIG. 15 is a table illustrating an example of a relationship between the second power voltage ELVSS outputted by a voltage generator 700 of FIG. 1, a setting threshold current SITH and a threshold current ITH.

Referring to FIGS. 1-15 , when the setting threshold current SITH is set to the first setting threshold current (e.g., 5 mA), and the reference power voltage RVSS is set to -2 V, the threshold current ITH may be about 6 mA at -4 V of the second power voltage ELVSS. The threshold current ITH may be about 15 mA at -2 V of the second power voltage ELVSS. The threshold current ITH may be about 16 mA at -1.95 V of the second power voltage ELVSS. The threshold current ITH may be about 39 mA at -1 V of the second power voltage ELVSS.

When the setting threshold current SITH is set to the second setting threshold current (e.g., 10 mA), and the reference power voltage RVSS is set to -2 V, the threshold current ITH may be about 10 mA at -4 V of the second power voltage ELVSS. The threshold current ITH may be about 27 mA at -2 V of the second power voltage ELVSS. The threshold current ITH may be about 16 mA at -1.95 V of the second power voltage ELVSS. The threshold current ITH may be about 38 mA at -1V of the second power voltage ELVSS. By selecting the reference threshold current data RD instead of the to one of the setting threshold current data ID at or below the reference power voltage RVSS, the threshold current ITH at or below the reference power voltage RVSS (e.g., -1.95V and -1V) of the second power voltage ELVSS may correspond to the threshold current ITH where the setting threshold current is the first setting threshold current (e.g., 5 mA).

When the setting threshold current SITH is set to the third setting threshold current (e.g., 15 mA) and the reference power voltage RVSS is set to -2 V, the threshold current ITH may be about 16 mA at -4 V of the second power voltage ELVSS. The threshold current ITH may be about 40 mA at -2 V of the second power voltage ELVSS. The threshold current ITH may be about 16 mA at -1.95 V of the second power voltage ELVSS. The threshold current ITH may be about 39 mA at -1 V of the second power voltage ELVSS. By selecting the reference threshold current data RD instead of the to one of the setting threshold current data ID at or below the reference power voltage RVSS, the threshold current ITH at or below the reference power voltage RVSS (e.g., -1.95V and -1V) of the second power voltage ELVSS may correspond to the threshold current ITH where the setting threshold current is the first setting threshold current (e.g., 5 mA).

When the setting threshold current SITH is set to the fourth setting threshold current (e.g., 20 mA) and the reference power voltage RVSS is set to -2 V, the threshold current ITH may be about 21 mA at -4 V of the second power voltage ELVSS. The threshold current ITH may be about 49 mA at -2 V of the second power voltage ELVSS. The threshold current ITH may be about 16 mA at -1.95 V of the second power voltage ELVSS. The threshold current ITH may be about 38 mA at -1 V of the second power voltage ELVSS. By selecting the reference threshold current data RD instead of the to one of the setting threshold current data ID at or below the reference power voltage RVSS, the threshold current ITH at or below the reference power voltage RVSS (e.g., -1.95V and -1V) of the second power voltage ELVSS may correspond to the threshold current ITH where the setting threshold current is the first setting threshold current (e.g., 5 mA).

In the present embodiment, when the absolute value of the second power voltage ELVSS becomes lower than the absolute value of the reference power voltage RVSS, the threshold current ITH may change by selecting the reference threshold current data RD instead of the setting one of the threshold current data ID. For example, when the absolute value of the second power voltage ELVSS becomes lower than the absolute value of the reference power voltage RVSS, the threshold current ITH may decrease because the reference threshold current data RD may be smaller than the setting threshold current data ID. As the threshold current ITH may decreases when the absolute value of the second power voltage ELVSS is lower than the absolute value of the reference power voltage RVSS, the voltage generator 700 may change operation mode from the low power mode to the normal mode even when the load IPL is low. Accordingly, the voltage generator 700 may operate in the normal mode when the absolute value of the second power voltage ELVSS decreases, and a ripple of the second power voltage ELVSS may be reduced. Accordingly, occurrences of flicker on the display panel 100 may be reduced, thereby improving a display quality of the display panel 100.

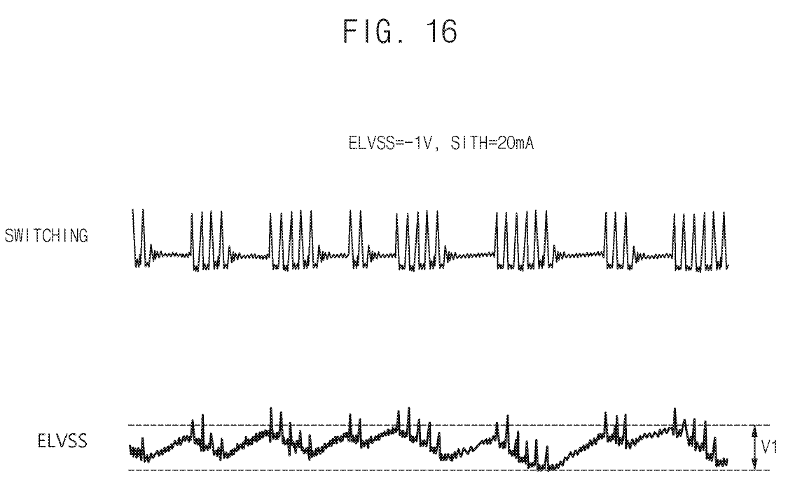

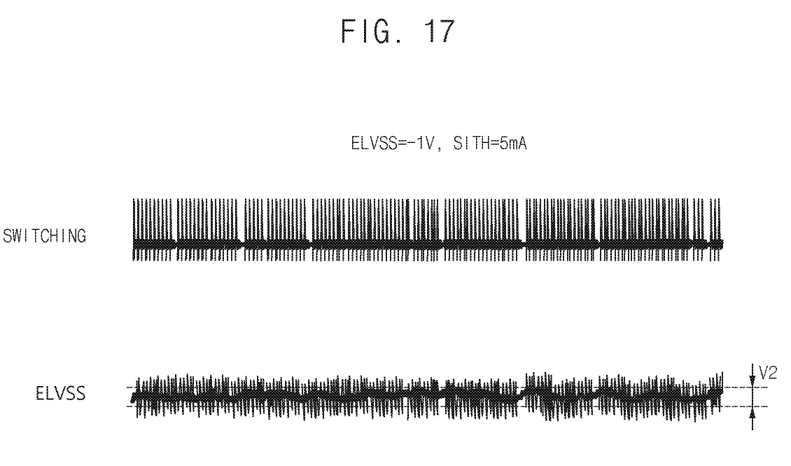

FIG. 16 is a waveform illustrating a fluctuation of a second power voltage ELVSS in a comparative example. FIG. 17 is a waveform illustrating a fluctuation of a second power voltage ELVSS in the present embodiment.

Referring to FIGS. 1-17 , in a comparative example, the setting threshold current may be set to 20 mA. When the second power voltage ELVSS is about -1 V, a ripple of the second power voltage ELVSS may correspond to a first voltage variation range V1.

In contrast, in the present embodiment, the setting threshold current may be set to 5 mA by selecting the reference threshold current data RD (e.g., 5 mA) instead of selecting one of the setting threshold current data ID (e.g., 20 mA) at or below the reference power voltage RVSS (e.g., -2V). When the second power voltage ELVSS is about -1 V and the setting threshold current is about 5 mA, a ripple of the second power voltage ELVSS may correspond to a second voltage variation range V2, which is smaller than the first voltage variation range V1.

Accordingly, in the present embodiment, a ripple of the second power voltage ELVSS may be reduced, and occurrences of flicker on the display panel 100 may be reduced. As a result, a display quality of the display panel 100 may be improved.

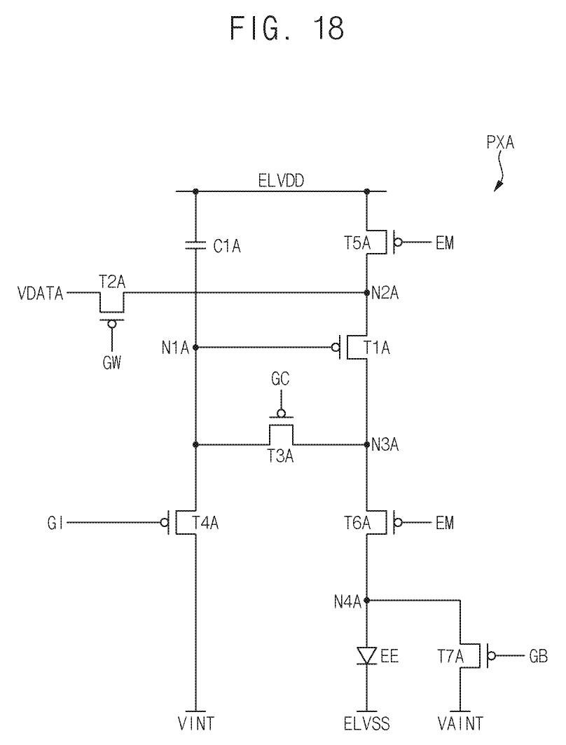

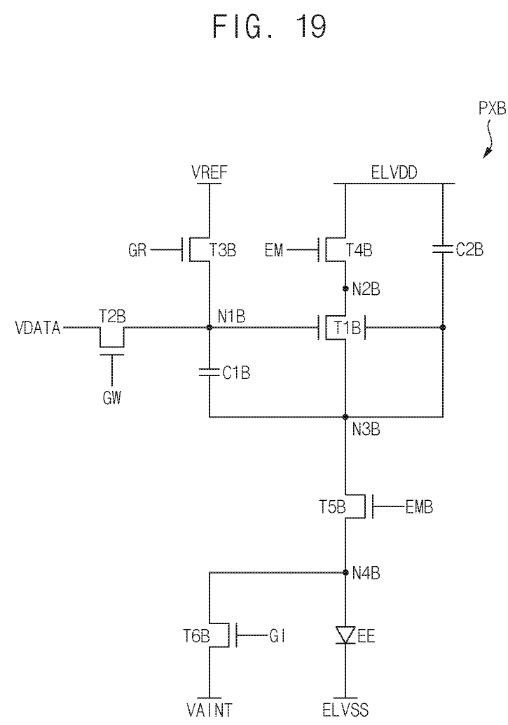

FIG. 18 is a circuit diagram illustrating an example of a pixel circuit PX included a display device 1 of FIG. 1.

Referring to FIGS. 1 and 18 , a pixel circuit PXA may include a first transistor T1A, a second transistor T2A, a third transistor T3A, a fourth transistor T4A, a fifth transistor T5A, a sixth transistor T6A, a seventh transistor T7A, a storage capacitor C1A and the light emitting element EE.

The first transistor T1A may include a control electrode connected to a first node N1A, a first electrode connected to a second node N2A and a second electrode connected to a third node N3A. The first transistor T1A may generate a driving current based on a voltage of the first node N1A. The first transistor T1A may be referred to as a driving transistor. In the present embodiment, the first transistor T1A may be P-type transistor.

The second transistor T2A may include a control electrode receiving a write gate signal GW, a first electrode receiving the data voltage VDATA and a second electrode connected to the second node N2A. The second transistor T2A may transfer the data voltage VDATA to the second node N2A in response to the write gate signal GW. The second transistor T2A may be referred to as a write transistor.

The third transistor T3A may include a control electrode receiving the compensation gate signal GC, a first electrode connected to the third node N3A and a second electrode connected to the first node N1A. The third transistor T3A may connect the first node N1A and the third node N3A in response to the compensation gate signal GC. The first transistor T1A is connected in a diode form when the third transistor T3A is turned-on in response to the compensation gate signal GC. The third transistor T3A may be referred to as a compensation transistor.

The fourth transistor T4A may include a control electrode receiving the initialization gate signal GI, a first electrode receiving the initialization voltage VINT and a second electrode connected to the first node N1A. The fourth transistor T4A may transfer the initialization voltage VINT to the first node N1A in response to the initialization gate signal GI. The fourth transistor T4A may be referred to as an initialization transistor.

The fifth transistor T5A may include a control electrode receiving the emission signal EM, a first electrode receiving the high power voltage ELVDD and a second electrode connected to the second node N2A. The fifth transistor T5A may supply the high power voltage ELVDD to the second node N2A in response to the emission signal EM. The fifth transistor T5A may be referred to as a first emission transistor.

The sixth transistor T6A may include a control electrode receiving the emission signal EM, a first electrode connected to the third node N3A and a second electrode connected to a fourth node N4A. The sixth transistor T6A may connect the third node N3A and the fourth node N4A in response to the emission signal EM. The sixth transistor T6A may be referred to as a second emission transistor.

The seventh transistor T7A may include a control electrode receiving the bias gate signal GB, a first electrode receiving the light emitting element initialization voltage VAINT and a second electrode connected to the fourth node N4A. The seventh transistor T7A may transfer the initialization voltage VAINT to the fourth node N4A in response to the initialization gate signal GB.

The storage capacitor C1A may include a first electrode receiving the high power voltage ELVDD and a second electrode connected to the first node N1A. The storage capacitor C1A may store a voltage of the first node N1A. The first capacitor C1A may be referred to as a storage capacitor.

The light emitting element EE may include a first electrode connected to the fourth node N4A and a second electrode receiving a low power voltage ELVSS. The light emitting element EE may emit light based on the driving current.

FIG. 19 is a circuit diagram illustrating an example of a pixel circuit PX included a display device 1 of FIG. 1.

Referring to FIGS. 1 and 19 , a pixel circuit PXB may include a first transistor T1B, a second transistor T2B, a third transistor T3B, a fourth transistor T4B, a fifth transistor T5B, a sixth transistor T6B, a first capacitor C1B and the light emitting element EE. In an embodiment, the pixel PXB may further include a second capacitor C2B.

The first transistor T1B may include a control electrode connected to a first node N1B, a first electrode connected to a second node N2B and a second electrode connected to a third node N3B. The first transistor T1B may generate driving current based on a voltage of the first node N1B. In an embodiment, the first transistor T1B may further include a back-gate control electrode connected to the third node N3B. The first transistor T1B may be referred to as a driving transistor. In the present embodiment, the first transistor T1B may be an N-type transistor.

The second transistor T2B may include a control electrode receiving the write gate signal GW, a first electrode receiving the data voltage VDATA and a second electrode connected to the first node N1B. The second transistor T2B may transfer the data voltage VDATA to the first node N1B in response to the write gate signal GW. The second transistor T2B may be referred to as a write transistor.

The third transistor T3B may include a control electrode receiving a reset gate signal GR, a first electrode receiving a pixel reference voltage VREF and a second electrode connected to the first node N1B. The third transistor T3B may transfer the pixel reference voltage VREF to the first node N1B in response to the reset gate signal GR. The third transistor T3B may be referred to as an initialization transistor.

The fourth transistor T4B may include a control electrode receiving an emission signal EM, a first electrode receiving the first power voltage ELVDD and a second electrode connected to the second node N2B. The fourth transistor T4B may supply the first power voltage ELVDD to the second node N2B in response to the emission signal EM. The fourth transistor T4B may be referred to as a first emission transistor.

The fifth transistor T5B may include a control electrode receiving a second emission signal EMB, a first electrode connected to the third node N3B and a second electrode connected to a fourth node N4B. The fifth transistor T5B may connect the third node N3B and the fourth node N4B in response to the second emission signal EMB. The fifth transistor T5B may be referred to as a second emission transistor.

The sixth transistor T6B may include a control electrode receiving the initialization gate signal GI, a first electrode receiving the light emitting element initialization voltage VAINT and a second electrode connected to the fourth node N4B. The sixth transistor T6B may transfer the light emitting element initialization voltage VAINT to the fourth node N4B in response to the initialization gate signal GI. The sixth transistor T6C may be referred to as a light emitting element initialization transistor.

The first capacitor C1B may include a first electrode connected to the first node N1B and a second electrode connected to the third node N3B. The second capacitor C2B may include a first electrode receiving the first power voltage ELVDD and a second electrode connected to the third node N3B.

The light emitting element EE may include a first electrode connected to the fourth node N4B and a second electrode receiving the second power voltage ELVSS. The light emitting element EE may emit light based on the driving current.

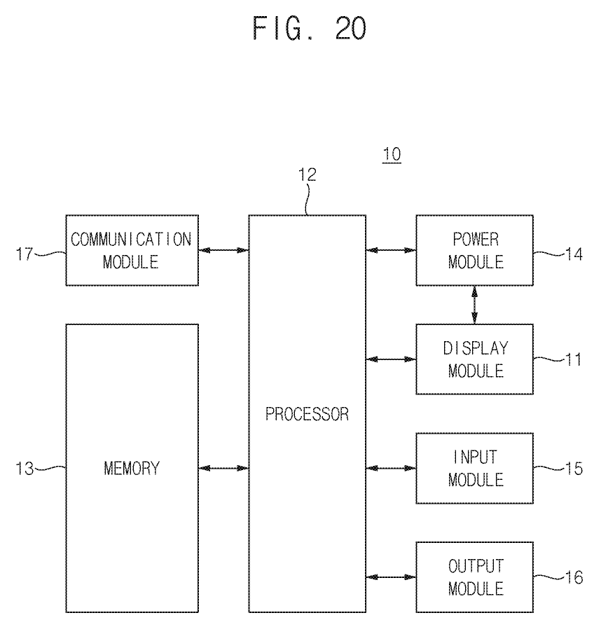

FIG. 20 is a block diagram illustrating an electronic device 10 according to embodiments of the present inventive concept.

Referring to FIG. 20, an electronic device 10 according to an embodiment may include a display module 11, a processor 12, a memory 13 and a power module 14.

The processor 12 may include at least one of a central processing unit (CPU), an application processor (AP), a graphic processing unit (GPU), a communication processor (CP), an image signal processor (ISP), and a controller. The processor 12 may output the input control signal CONT of FIG. 1.

The memory 13 may store data information necessary for the operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module, such as a power adapter or a battery device, and a power conversion module which converts power supplied by the power supply module to generate power required for the operation of the electronic device 10. In an embodiment, the power module 14 may be the voltage generator 700 of FIG. 1.

The electronic device 10 may further include an input module 15, a non-image output module 16 and/or a communication module 17.

The input module 15 may provide input information to the processor 12 and/or the display module 11. The input module 15 may include various sensor modules as well as physical buttons, a keyboard, and a microphone. Examples of the sensor modules may include a touch sensor, a pressure sensor, a distance sensor, a position sensor, a digitizer, a motion recognition sensor, a camera sensor, a light receiving sensor, a photoelectric conversion sensor, a temperature sensor, and a biosensor such as a blood pressure sensor, a blood sugar sensor, an electrocardiogram sensor, and a heart rate sensor.

The non-image output module 16 may receive information other than images from the processor 12 and provide the information to the user. Examples of the non-image output module 16 may include an audio module, a haptic module, a light-emitting module, etc., and may include other functional modules unique to electronic devices (e.g., a cooling module of a refrigerator, etc.).

The communication module 17 may be a module that is responsible for transmitting and receiving information between the electronic device 10 and an external device, and may include a receiving unit and a transmitting unit. The communication module 17 may include various wireless communication modules such as a mobile communication module, a Wi-Fi module, a Bluetooth module, or various wired communication modules.

At least one of the components of the electronic device 10 described above may be included in the display device according to the embodiments described above. Additionally, some of the functional sub-modules of a module may be included in the display device, and others may be provided as separate components outside the display device. For example, the display device may include the display module 11, and the processor 12, the memory 13, and the power module 14 may be provided in the form of other devices within the electronic device 10 other than the display device.

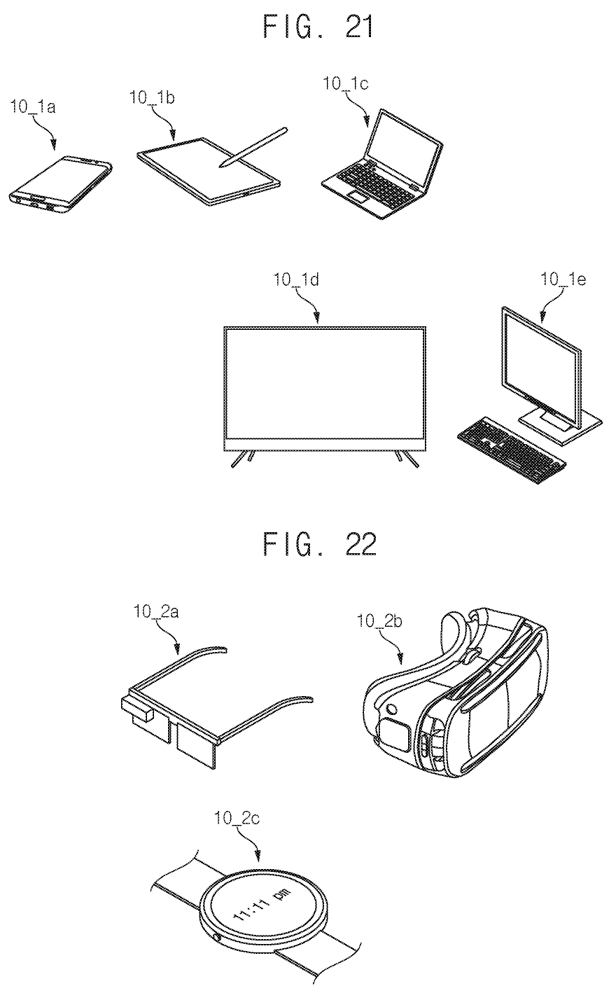

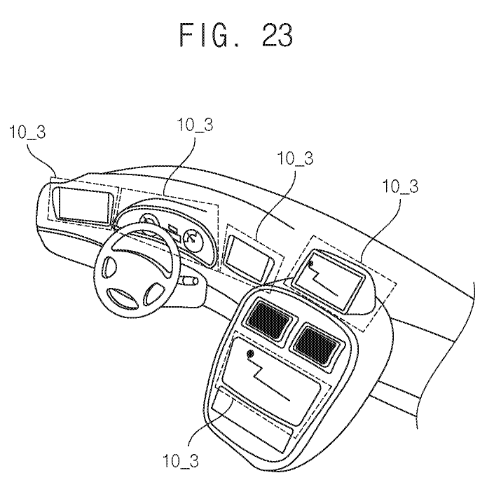

FIGS. 21-23 are schematic diagrams illustrating an electronic device according to embodiments.

Referring to FIG. 21, a smartphone 10_1a, a tablet PC 10_1b, a laptop 10_1c, a TV 10_1d, and a desk monitor 10_1e are examples of electronic devices.

The smartphone 10_1amay include an input module such as a touch sensor and a communication module in addition to the display module 11. The smartphone 10_1amay process information received through the communication module or other input modules and display the information through the display module of the display device.

In the case of tablet PC 10_1b, laptop 10_1c, TV 10_1d, and desk monitor 10_1e, may include a display module and an input module similar to the smartphone 10_1a, and in some cases, may further include a communication module.

Referring to FIG. 22, an electronic device including a display module may be applied to a wearable electronic device. The wearable electronic device may be a smart glasses 10_2a, a head mounted display 10_2b, a smart watch 10_2c, etc.

The smart glasses 10_2a and head mounted displays 10_2b may include a display module which emits a display image and a reflector which reflects the emitted display image and provides it to the user's eyes, thereby providing a virtual reality or augmented reality screen to the user.

The smartwatch 10_2cmay include a biometric sensor as an input device and may provide biometric information recognized by the biometric sensor to the user through a display module.

Referring to FIG. 23, an electronic device including a display module may be applied to a vehicle. For example, the electronic device 10_3 may be applied to a dashboard, center fascia, etc. of a vehicle, or may be applied to a CID (Center Information Display) placed on a dashboard of a vehicle or a room mirror display replacing a side mirror.

Although not illustrated, electronic devices to which the display device according to the embodiments is applied may include not only devices that mainly display screens, such as billboards, electronic boards, and game consoles, but also various home appliances that display information through display modules, such as refrigerators, washing machines, dryers, air conditioners, and robot vacuum cleaners. Additionally, when the display module has a function of transmitting light, it may be applied to electronic devices, such as smart windows or transparent display devices that display a background and a display image together. The type of electronic device according to the embodiment is not limited to the examples described herein, and may also be applied to other various electronic devices that are not specifically illustrated.

The display device according to the embodiments may be applied to a display device included in a computer, a notebook, a mobile phone, a smart phone, a smart pad, a PMP, a PDA, an MP3 player, or the like.

The foregoing examples are illustrative purpose only and is not to be construed as limiting the present inventive concept. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A display device comprising:
a display panel including a pixel circuit; and
a voltage generator configured to generate a panel power voltage based on an input voltage, and to supply the panel power voltage to the display panel,
wherein the voltage generator is configured to control an output level of the panel power voltage by switching its operation mode based on a magnitude of a load current relative to a threshold current,
wherein, when an absolute value of the panel power voltage is greater than an absolute value of a reference power voltage, as the absolute value of the panel power voltage decreases from a first absolute value to a second absolute value, the threshold current increases from a first threshold current to a second threshold current accordingly,
wherein, when the absolute value of the panel power voltage is lower than the absolute value of the reference power voltage, as the absolute value of the panel power voltage decreases from a third absolute value to a fourth absolute value, the threshold current increases from a third threshold current to a fourth threshold current, and
wherein the voltage generator is configured to control the third threshold current at the third absolute value of the panel power voltage to be smaller than the second threshold current at the second absolute value of the panel power voltage.

2. The display device of claim 1, wherein, the voltage generator is configured to operate in a low power mode when the load current is smaller than the threshold current, and to operate in a normal mode when the load current is greater than the threshold current.

3. The display device of claim 2, wherein, a frequency of switching a switching element included in the voltage generator in the low power mode is lower than a frequency of switching the switching element in the normal mode.

4. The display device of claim 1, wherein, when the absolute value of the panel power voltage is greater than the absolute value of the reference power voltage, the threshold current increases as the absolute value of the panel power voltage decreases, and, when the absolute value of the panel power voltage is lower than the absolute value of the reference power voltage, the threshold current increases as the absolute value of the panel power voltage decreases.

5. The display device of claim 1, wherein the voltage generator includes:
a first controller configured to control an output of the panel power voltage based on a pulse skip control signal;
an amplifier configured to output the pulse skip control signal based on a pulse skip reference voltage; and
a second controller configured to control the pulse skip reference voltage based on the threshold current.

6. The display device of claim 5, wherein the second controller includes:
a multiplexer configured to output one of a setting threshold current data or a reference threshold current data based on a selecting signal; and
a reference voltage generator configured to generate the pulse skip reference voltage based on the output of the multiplexer.

7. The display device of claim 6, wherein the second controller further includes a logic gate which outputs the selecting signal based on a reference power voltage data and a power voltage data.

8. The display device of claim 7, wherein, when the absolute value of the panel power voltage is lower than an absolute value of the reference power voltage, the power voltage data has a logic high level, and the selecting signal has a logic high level, such that the multiplexer outputs the reference threshold current data as the pulse skip reference voltage.

9. The display device of claim 7, wherein, when the absolute value of the panel power voltage is higher than an absolute value of the reference power voltage, the power voltage data has a logic low level, and the selecting signal has a logic low level, such that the multiplexer outputs the setting threshold current data as the pulse skip reference voltage.

10. The display device of claim 7, wherein the multiplexer includes a first terminal receiving the setting threshold current data, a second terminal receiving the reference threshold current data, a third terminal receiving the selecting signal and an output terminal outputting one of the setting threshold current data or the reference threshold current data, wherein the logic gate includes a first terminal receiving the reference power voltage data, a second terminal receiving the power voltage data and an output terminal outputting the selecting signal.

11. The display device of claim 7, wherein the logic gate is an AND gate configured to perform a logical AND operation between the reference power voltage data and the power voltage data.

12. An electronic device comprising:
a display panel including a pixel circuit;
a display panel driver configured to control the display panel based on an input control signal; and
a processor configured to output the input control signal,
wherein the display panel driver includes a voltage generator configured to apply a panel power voltage to the display panel based on an input voltage,
wherein the voltage generator is configured to control an output level of the panel power voltage by switching its operation mode based on a magnitude of a load current relative to a threshold current,
wherein, when an absolute value of the panel power voltage is greater than an absolute value of a reference power voltage, as the absolute value of the panel power voltage decreases from a first absolute value to a second absolute value, the threshold current increases from a first threshold current to a second threshold current accordingly,
wherein, when the absolute value of the panel power voltage is lower than the absolute value of the reference power voltage, as the absolute value of the panel power voltage decreases from a third absolute value to a fourth absolute value, the threshold current increases from a third threshold current to a fourth threshold current, and
wherein the voltage generator is configured to control the third threshold current at the third absolute value of the panel power voltage to be smaller than the second threshold current at the second absolute value of the panel power voltage.

13. The electronic device of claim 12, wherein, the voltage generator is configured to operate in a low power mode when the load current is smaller than the threshold current, and to operate in a normal mode when the load current is greater than the threshold current, and, a frequency of switching a switching element included in the voltage generator in the low power mode is smaller than a frequency of switching the switching element in the normal mode.

14. The electronic device of claim 12, wherein, when the absolute value of the panel power voltage is greater than the absolute value of the reference power voltage, the threshold current increases as the absolute value of the panel power voltage decreases, and when the absolute value of the panel power voltage becomes lower than the reference power voltage, the threshold current decreases, and when the absolute value of the panel power voltage is lower than an absolute value of the reference power voltage, the threshold current increases as the absolute value of the panel power voltage decreases.

15. The electronic device of claim 12, wherein the voltage generator includes:
a first controller configured to control an output of the panel power voltage based on a pulse skip control signal;
an amplifier configured to output the pulse skip control signal based on a pulse skip reference voltage; and
a second controller configured to control the pulse skip reference voltage based on the threshold current.

16. The electronic device of claim 15, wherein the second controller includes:
a multiplexer configured to output one of a setting threshold current data or a reference threshold current data based on a selecting signal; and
a reference voltage generator configured to generate the pulse skip reference voltage based on the output of the multiplexer.

17. The electronic device of claim 16, wherein the second controller further includes a logic gate which outputs the selecting signal based on a reference power voltage data and a power voltage data.

18. The electronic device of claim 17, wherein when the absolute value of the panel power voltage is lower than an absolute value of the reference power voltage, the power voltage data has a logic high level, and the selecting signal has a logic high level, such that the multiplexer outputs the reference threshold current data as the pulse skip reference voltage, and wherein, when the absolute value of the panel power voltage is higher than an absolute value of the reference power voltage, the power voltage data has a logic low level, and the selecting signal has a logic low level, such that the multiplexer outputs the setting threshold current data as the pulse skip reference voltage.

19. A method for operating a display device, comprising:
supplying, by a voltage generator, a panel power voltage to a display panel of the display device;
controlling a level of the panel power voltage by switching operation mode of the voltage generator between a low power mode and a normal mode based on magnitude of a load current relative to a threshold current, wherein the voltage generator operates in a low power mode when the load current is smaller than the threshold current, and operates in a normal mode when the load current is greater than the threshold current; and
in response to an absolute value of the panel power voltage becoming lower than a reference power voltage, decreasing the threshold current by selecting a reference threshold current data as a pulse skip reference voltage.

20. The method of claim 19, further comprising controlling the voltage generator to reduce a frequency of switching a switching element included in the voltage generator in the low power mode to be lower than a frequency of switching the switching element in the normal mode.
